(19) United States
(12) Patent Application Publication
(10) Pub. No.: US 2021/0174726 A1
(43) Pub. Date: Jun. 10, 2021

(54) METHOD OF USING A DYNAMIC LIGHT FIELD SYSTEM

(71) Applicant: AMERICAN FUTURE TECHNOLOGY, City of Industry, CA (US)

(72) Inventor: You-Chi LIU, City of Industry, CA (US)

(21) Appl. No.: 17/091,771

(22) Filed: Nov. 6, 2020

(30) Foreign Application Priority Data
Dec. 4, 2019 (TW) 108144372

(51) Int. Cl. G09G 3/20; G06T 7/90; G09G 3/32; G09G 3/00; H05B 47/16; H05B 47/105

(52) U.S. Cl. CPC G09G 3/2003; G06T 7/90; G09G 3/32; G09G 3/001; G06T 2207/10024; H05B 47/105; G09G 2370/16; G09G 2320/0666; H05B 47/16

(57) ABSTRACT

A dynamic light field system and its method of use is disclosed. The processing module of the controller of the dynamic light field system first performs a color analysis operation on multiple picture files to find the corresponding plural international color codes, and then transmits the international color codes and a timing signal to respective light-emitting devices, so that the processing units of the light-emitting devices drives the respective light-emitting elements to emit light according to the multiple international color codes and the timing signal, thereby creating a dynamic light field based on the picture files.

This application claims the priority benefit of Taiwan patent application number 108144372, filed on Dec. 4, 2019.

### BACKGROUND OF THE INVENTION

### 1. Field of the Invention

The present invention relates to light-field technology and more particularly, to a dynamic light field system and its method of use, which uses a controller to analyze the color of multiple picture files and drive multiple light-emitting devices to project light outward based on the color analysis results, thereby creating a dynamic light field effect.

### 2. Description of the Related Art

Today's lighting system is getting more and more advanced. LED lighting has the advantages of adjustable dimming function, low power consumption, small size, being not easy to break or damage, and long service life. Therefore, LED lighting systems will continue to spread. As the current lighting system is advanced, flexible and more integrated, the light system in many fields (such as: game industry, retail industry, hotel industry or home filed, etc.) will enhance the experience through the lighting system, thereby improving productivity, safety, efficiency and leisure.

Furthermore, in order to enhance the light lighting experience, some manufacturers use programs to control the LED lighting system to change the color and lighting time of the LEDs, and then create a light scene (for example, to create scenes such as torches or the sea). However, the conventional light scene setting needs to be written in the program in advance by the manufacturer, and then provided to the user to choose to use, so the user's choice will be limited to the scene in the program. For users, it is very unattractive, and the scene cannot be adjusted according to their own preferences, resulting in loss of willingness to buy.

### SUMMARY OF THE INVENTION

The present invention has been accomplished under the circumstances in view. It is a first object of the present invention to provide a dynamic light field system, which comprises a controller comprising a processing module, a transmission module and a power supply device, and a plurality of light-emitting devices each comprising a transmission unit, a processing unit, a plurality of light-emitting elements and a power supply unit. The processing module of the controller first performs a color analysis operation on a plurality of picture files to compare the color pixels (RGB values) in the picture files with the international color code table and then analyze the color pixels in the picture files to find the corresponding plural international color codes. Then, the processing module of the controller uses the internal timing unit to add a timing signal to the picture files, and transmits the international color codes and the timing signal to the transmission modules of the light-emitting devices, enabling the transmission modules to transmit the multiple international color codes and the timing signal to the respective transmission units. Then, the processing units perform light-emitting operations according to the multiple international color codes and the timing signal to drive the respective light-emitting elements, so that the light-emitting elements of the light-emitting devices continuously play the picture files according to the time arranged by the timing signal, and display the corresponding colors according to the multiple international color codes, and thus, the light-emitting devices displaying a dynamic light field based on the picture files. Because the effect of the dynamic light field can be created by the multiple light-emitting elements of the multiple light-emitting devices, the dynamic light field system increases the diversity of use and reduces the difficulty of dynamic light field production, thereby achieving the purpose of improving the convenience of overall production and use.

It is another object of the present invention to provide a dynamic light field system, wherein the timing unit of the processing module can be controlled by an electronic device, and the timing can be changed by the electronic device, thereby adjusting the time for the bright display of the multiple light-emitting elements to improve the variability during use, so as to achieve the effect of increasing market competitiveness.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of a dynamic light field system in accordance with the present invention.

FIG. 2 is an oblique top elevational view of the dynamic light field system in accordance with the present invention.

FIG. 3 is a flow chart of the method of use of the dynamic light field system in accordance with the present invention.

FIG. 4 is a schematic drawing of multiple picture files of the present invention.

FIG. 5 is a front view of the light-emitting devices of the dynamic light field system in accordance with the present invention before use.

FIG. 6 is a schematic drawing illustrating a status of use of the light-emitting devices of the dynamic light field system in accordance with the present invention (I).

FIG. 7 is a schematic drawing illustrating a status of use of the light-emitting devices of the dynamic light field system in accordance with the present invention (II).

### DETAILED DESCRIPTION OF THE PREFERRED EMBODIMENT

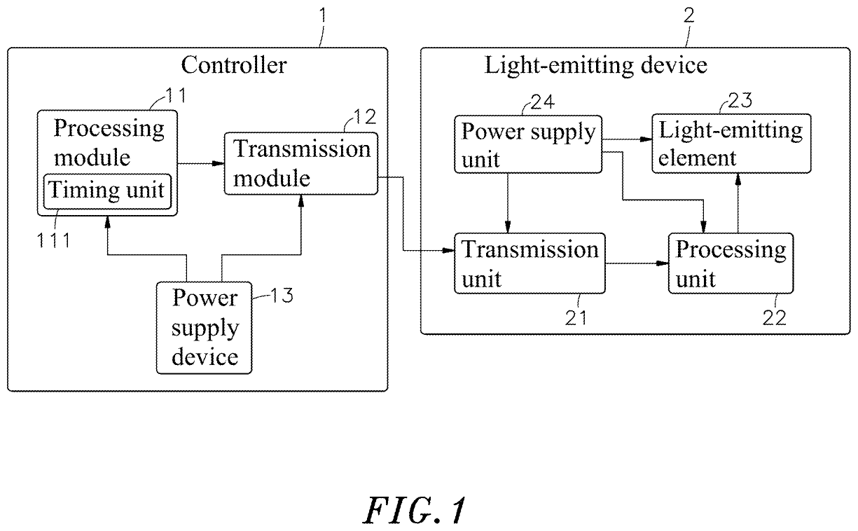

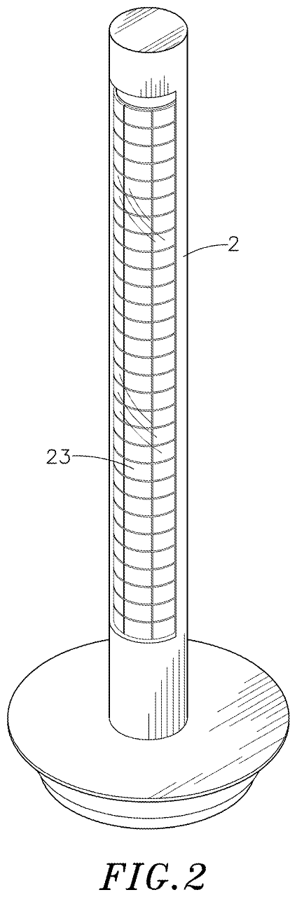

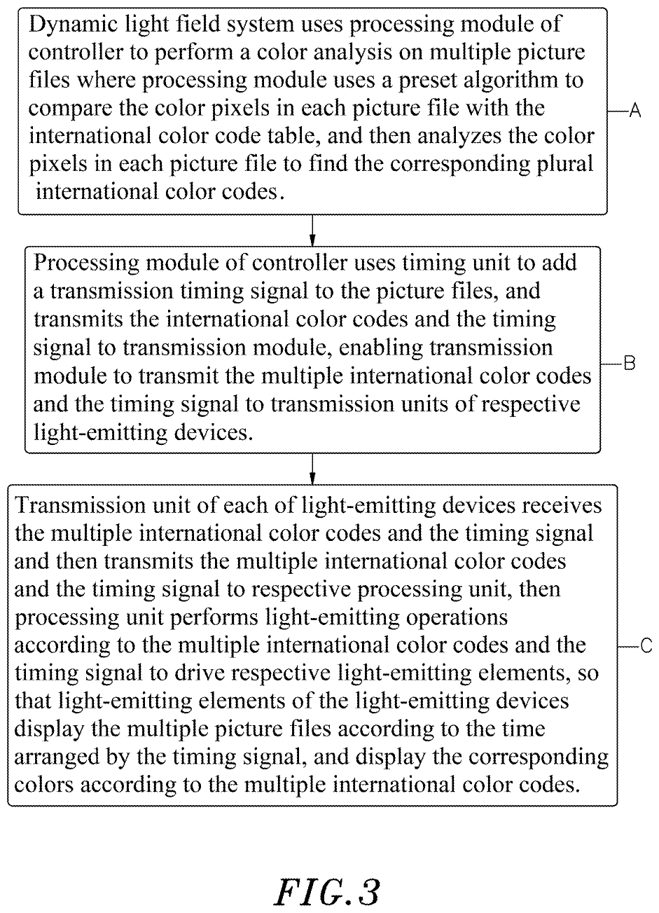

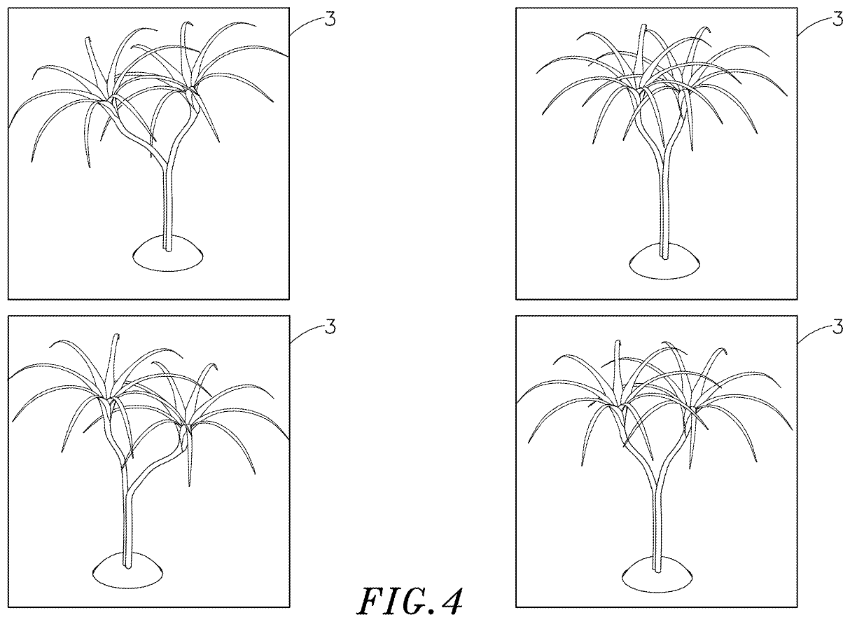

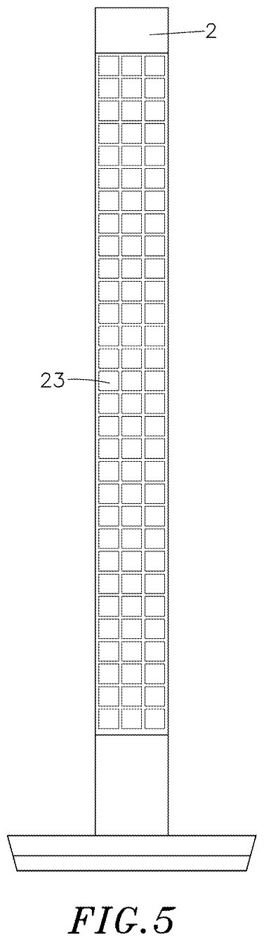

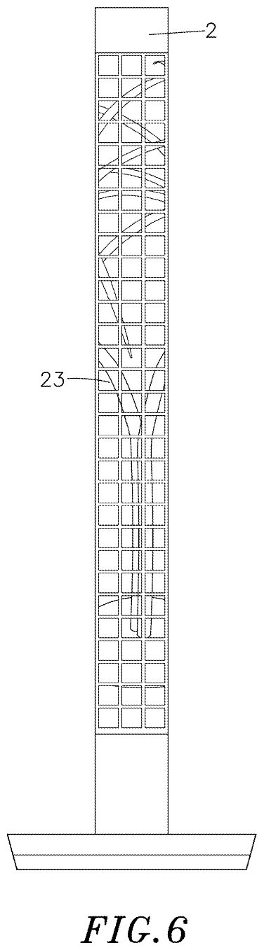

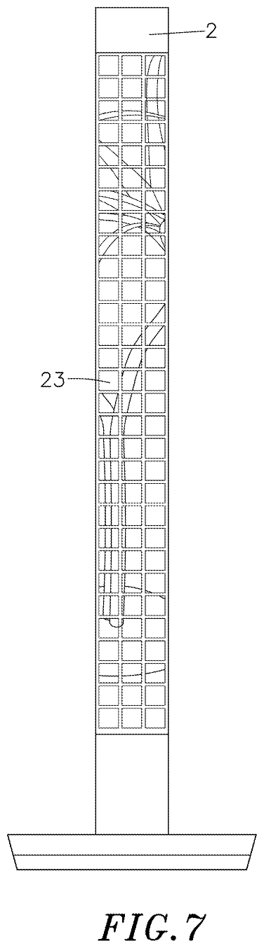

Referring to FIGS. 1-7, a dynamic light field system in accordance with the present invention comprises a controller 1 and a plurality of light-emitting devices 2.

The controller 1 comprises a processing module 11 with a timing unit 111 arranged therein, a transmission module 12 electrically connected to one end of the processing module 11, and a power supply device 13 electrically connected to an opposite end of the processing module 11 to provide power for the operation of the controller 1.

The light-emitting device 2 comprises a transmission unit 21 that can receive the signal transmitted by the transmission module 12, a processing unit 22 electrically connected with one end thereof to the transmission unit 21, a plurality of light-emitting elements 23 (such as light-emitting diodes) arranged in an array and electrically connected to an opposite end of the processing unit 22 for emitting multiple colors of light, and a power supply unit 24 adapted to provide power for the operation of the light-emitting device 2.

The transmission module 12 of the controller 1 and the transmission unit 21 of each light-emitting device 2 can be a wired transmission interface or a wireless transmission interface for mutual signal transmission. The wired transmission interface can be a wired connection interface such as USB (universal serial bus), micro-USB, mini-USB, etc. The wireless transmission interface can be a short-range communication device (such as Bluetooth module or WiFi module).

Furthermore, the power supply device 13 of the controller 1 and the power supply unit 24 of the light-emitting device 2 can be electrically connected to an external power source using a power transmission line (not shown; such as a power plug, etc.). The external power source can be a city power socket or a generator power socket that provides the power required by the controller 1 and the light-emitting device 2. But in practical applications, it can also be connected to an external portable power storage device through a USB power transmission line (such as a portable charger). However, there are many ways and structures for the controller 1 and the light-emitting device 2 to obtain electric energy. It only needs to provide electric energy to the controller 1 and the light-emitting device 2, and the detailed composition of the structure is not the main point of the invention and will not be repeated here.

The above-mentioned light-emitting devices 2 can be lamp posts, ceiling lamps, or decorative lamps set on the edge of a chair cushion, etc., which can project light outward.

When the method of using the dynamic light field system of the present invention is actually executed, it includes the following steps:

(A) The dynamic light field system uses the processing module 11 of the controller 1 to perform a color analysis on a plurality of picture files 3 where the processing module 11 uses a preset algorithm to compare the color pixels (RGB values) in each picture file 3 with the international color code table, and then analyzes the color pixels in each picture file 3 to find the corresponding plural international color codes.

(B) The processing module 11 of the controller 1 uses the internal timing unit 111 to add a transmission timing signal to the picture files 3, and transmits the international color codes and the timing signal to the transmission module 12, enabling the transmission module 12 to transmit the multiple international color codes and the timing signal to the transmission units 21 of the light-emitting devices 2.

(C) The transmission units 21 of the light-emitting devices 2 receive the multiple international color codes and the timing signal and then transmit the multiple international color codes and the timing signal to the respective processing units 22, then the processing units 22 perform light-emitting operations according to the multiple international color codes and the timing signal to drive the respective light-emitting elements 23, so that the light-emitting elements 23 of the light-emitting devices 2 continuously display the picture files 3 according to the time arranged by the timing signal, and display the corresponding colors according to the multiple international color codes. In this way, the light-emitting devices 2 display a dynamic light field based on the picture files 3.

In the above step (A), the picture files 3 can be transmitted to the processing module 11 of the controller 1 by an electronic device (such as a desktop computer, a notebook computer or a tablet computer, etc.). The electronic device can be installed with a default application program or a mobile application program, so that the picture files 3 to be transmitted can be selected through the default application program or the mobile application program. In step (B), you can adjust the interval timing between the multiple picture files 30, and then change the light display time of the light-emitting elements 23, and the timing is greater than zero seconds.

Furthermore, in the above-mentioned dynamic light field display, the plurality of light-emitting devices 2 can individually display a set of picture files 3, and then the multiple light-emitting devices 2 can cooperate with each other to display and create a dynamic light field. But in practical application, the plurality of light-emitting devices 2 can display a set of picture files 3 together, and the plurality of light-emitting devices 2 can be used to continuously play the picture files 3. In this way, a dynamic light field is displayed and created by continuously playing multiple picture files 3.

When the present invention is actually used, the plurality of picture files 3 are used as an example of showing the swinging of the grass. The processing module 11 of the controller 1 first performs a color analysis operation on the grass-swinging picture files 3. The processing module 11 compares the color pixels (RGB values) in the grass-swinging picture files 3 with the international color code table, and then analyzes the color pixels in the grass-swinging picture files 3 to find the corresponding plural international color codes. Then, the processing module 11 of the controller 1 adds a transmission timing signal to the grass-swinging picture files 3 and transmits the international color codes and the timing signal to the transmission units 21 of the light-emitting devices 2 through the transmission module 12. After received the multiple international color codes and the timing signal, the transmission units 21 of the at least one light-emitting devices 2 transmit the multiple international color codes and the timing signal to the respective processing units 22, then the processing units 22 perform light-emitting operations according to the multiple international color codes and the timing signal to drive the respective light-emitting elements 23, so that the light-emitting elements 23 of the light-emitting devices 2 continuously play grass-swinging picture files 3 according to the time arranged by the timing signal, and display the corresponding colors of the grass-swinging picture files 3 according to the multiple international color codes. In turn, multiple light-emitting devices 2 can be used to create and show the dynamic light field of the grass when it is swinging. Furthermore, the above-mentioned user can change the timing through an electronic device to control the swing speed of the grass displayed by multiple light-emitting devices 2.

The present invention has the following advantages:

1. The processing module 11 of the controller 1 first performs a color analysis operation on the picture files 3, and then drives the light-emitting devices 2 to emit light according to the analysis results, so that the light-emitting elements 23 of the light-emitting devices 2 continuously play the picture files 3 to create a dynamic light field effect. Compared with the conventional technology, users are not limited to the use of the built-in dynamic light field in the program, so as to increase the diversity of use, and only need to use the picture filed 3 to present the dynamic light field. It can reduce the difficulty of dynamic light field production, thereby achieving the effect of improving the overall production and convenience of use.

2. The timing unit 111 of the processing module 11 can be controlled by an electronic device, and the timing can be changed by the electronic device, thereby adjusting the time for the bright display of the multiple light-emitting elements 23 to improve the variability during use, so as to achieve the effect of increasing market competitiveness.

What the invention claimed is:

1. A method of using a dynamic light field system comprising a controller and a plurality of light-emitting devices, said controller comprising a processing module with a timing unit arranged therein, a transmission module, each said light-emitting device comprising a transmission unit, a processing unit, a plurality of light-emitting elements, the method comprising the steps of:
(a) said dynamic light field system using said processing module of said controller to perform a color analysis on a plurality of picture files where said processing module uses a preset algorithm to compare the color pixels (RGB values) in said picture files with the international color code table, and then analyzes the color pixels in said picture files to find the corresponding plural international color codes;
(b) said processing module of said controller uses said internal timing unit to add a timing signal to said picture filed, and transmits said international color codes and said timing signal to said transmission modules of said light-emitting devices, enabling said transmission modules to transmit said multiple international color codes and said timing signal to the respective said transmission units; and
(c) said transmission units of said light-emitting devices receiving said multiple international color codes and said timing signal and then transmitting said multiple international color codes and said timing signal to the respective said processing units, then said processing units performing light-emitting operations according to said multiple international color codes and said timing signal to drive the respective said light-emitting elements, so that said light-emitting elements of said light-emitting devices continuously play said picture files according to the time arranged by said timing signal, and display the corresponding colors according to said multiple international color codes, and thus, said light-emitting devices displaying a dynamic light field based on said picture files.

2. The method of using the dynamic light field system as claimed in claim 1, wherein in step (a), said picture files are transmitted to said processing module of said controller by an electronic device, said electronic device being installed with a default application program or a mobile application program, so that the picture files to be transmitted are selected through said default application program or said mobile application program; in step (b), the interval timing between said picture files that is greater than zero seconds is adjustable, so that the light display time of said light-emitting elements is changeable.
